(19) United States
(12) Patent Application Publication
(10) Pub. No.: US 2023/0041613 A1
(43) Pub. Date: Feb. 9, 2023

(54) METHOD OF PRIOR CHANNEL INFORMATION TRANSMISSION

(71) Applicant: ZTE CORPORATION, Shenzhen (CN)

(72) Inventors: Guozeng ZHENG, Shenzhen (CN); Zhaohua LU, Shenzhen (CN); Huahua XIAO, Shenzhen (CN); Chuangxin JIANG, Shenzhen (CN)

(21) Appl. No.: 17/870,741

(22) Filed: Jul. 21, 2022

Related U.S. Application Data
(63) Continuation of application No. PCT/CN2020/088336, filed on Apr. 30, 2020.

(51) Int. Cl. H04L 5/00; H04W 8/24; H04W 24/08

(52) U.S. Cl. CPC H04L 5/0058; H04W 8/24; H04L 5/0048; H04L 5/0044; H04W 24/08

(57) ABSTRACT

A wireless communication method for use in a user terminal comprises receiving, from a network entity or a first wireless network node, prior channel information related to at least one channel between each of at least one wireless terminal and each of at least one second wireless network node, and determining at least one characteristic of the user terminal based on the prior channel information.

### CROSS-REFERENCE TO RELATED APPLICATION

This application claims the benefit of priority under 35 U.S.C. § 120 as a continuation of PCT Patent Application No. PCT/CN2020/088336, filed on Apr. 30, 2020, the disclosure of which is incorporated herein by reference in its entirety.

### TECHNICAL FIELD

This document is directed generally to wireless communications, and in particular to 5^{th} generation (5G) new radio (NR) wireless communications.

### SUMMARY

In existing technologies, there are time- and angle-based methods for positioning a mobile terminal, such as time of arrival (TOA), receive signal time difference (RSTD) and Multi-round-trip-time (Multi-RTT), angle of departure (AOD), angle of arrival (AOA). However, performance of the aforementioned approaches largely depends on whether links (e.g. channels) of the mobile terminal being line-of-sight (LOS) links. When a probability of the links of the mobile being the LOS links is low, the performance of the aforementioned approaches is downgraded.

In addition, characteristics of the links of the mobile terminal may be so complex that it's hard for the mobile terminal to get enough information by simply receiving reference signals. Furthermore, when the mobile terminal is moving, the mobile terminal may need to predict channel quality, which is also hard to achieved by simply receiving the reference signals.

Thus, how to locate the mobile terminal and predict the channel quality becomes a topic to be discussed.

This document relates to wireless communication methods, user terminal, wireless network node, network entity and wireless terminal for transmitting prior channel information used for determining characteristic(s) of a user terminal.

The present disclosure relates to a wireless communication method for use in a user terminal. the wireless communication method comprises:

receiving, from a network entity or a first wireless network node, prior channel information related to at least one channel between each of at least one wireless terminal and each of at least one second wireless network node, and

determining at least one characteristic of the user terminal based on the prior channel information.

Various embodiments may preferably implement the following features:

Preferably, the wireless communication method further comprises:

receiving, from the at least one second wireless network node, reference signals on the at least one channel,

determining local channel information based on the reference signals, and

determining the at least one characteristic based on the prior channel information and the local channel information.

Preferably, the prior channel information comprises at least one of: channel impulse response, CIR; reference signal received power, RSRP; relative RSRP; path loss; relative path loss; path loss model; the first arriving path time; time difference of arrival; the first arriving path power; first arriving path power probability distribution function, PDF, of the first arriving path power; mean excess delay; delay spread; delay of strongest power path to the first arriving path; kurtosis; kurtosis PDF; skewness; skewness PDF; angle information, comprising at least one of: zenith of arrival, azimuth of arrival, zenith of departure or azimuth of departure; angle spread information, comprising at least one of: zenith angle spread of arrival, azimuth angle spread of arrival, zenith angle spread of departure or azimuth angle spread of departure; angle spread PDF of the angle spread, Rician K-factor; Rician K-factor PDF of the Rician K-factor; confidence level of the prior channel information; coordinate of each of the at least one second wireless network node, or coordinate of each of the at least one wireless terminal.

Among others, the prior channel information comprising the CIR has the advantageous effects of predicting/estimating CIR of the user terminal as training set or fingerprint and/or other kinds of channel characteristics may be extracted from the CIR for use in the user terminal.

Among others, the prior channel information comprising the RSRP has the advantageous effects of predicting/estimating RSRP of the user terminal as training set or fingerprint and estimating a location of the user terminal when combining with the local channel information (e.g. RSRP) of the user terminal and the coordinate(s) of the at least one second wireless network node and/or the coordinate(s) of the at least one wireless terminal.

Among others, the prior channel information comprising the relative RSRP has the advantageous effects that the same or similar relative RSRP can be acquired when different kinds of wireless (user) terminals are used, predicting/estimating relative RSRP of the user terminal as training set or fingerprint, and estimating a location of the user terminal when combining with the local channel information (e.g. relative RSRP) of the user terminal and the coordinate(s) of the at least one second wireless network node and/or the coordinate(s) of the at least one wireless terminal.

Among others, the prior channel information comprising the path loss has the advantageous effects of predicting/estimating path loss of the user terminal as training set or fingerprint, estimating a location of the user terminal when combining with the local channel information of the user terminal and coordinate(s) of the at least one second wireless network node and/or the coordinate(s) of the at least one wireless terminal, and benefiting cell section of the user terminal.

Among others, the prior channel information comprising the relative path loss has the advantageous effects that the same or similar relative path loss can be acquired when different kinds of wireless terminal are used, of predicting/estimating relative path loss of the user terminal as training set or fingerprint, estimating a location of the user terminal when combining with the local channel information of the user terminal and coordinate(s) of the at least one second wireless network node and/or the at least one wireless terminal and benefiting cell section of the user terminal.

Among others, the prior channel information comprising the path loss model has the advantageous effect of estimating the relative distance between the user terminal and the at least one second wireless network node for positioning when combining with local path loss of the user terminal.

Among others, the prior channel information comprising the RSRQ has the advantageous effect of predicting/estimating RSRQ of the user terminal as training set or fingerprint and estimating location of the user terminal when combining with local channel information of the user terminal.

Among others, the prior channel information comprising the relative RSRQ has the advantageous effects that the same or similar relative RSRQ can be acquired when different kinds of wireless terminal are used, of predicting/estimating relative RSRQ of the user terminal as training set or fingerprint and of estimating location of the user terminal when combining with local channel information of the user terminal.

Among others, the prior channel information comprising the first arriving path time has the advantageous effect of predicting/estimating the first arriving path time of the user terminal as training set or fingerprint and usage of positioning (e.g. time of arrival (TOA) method).

Among others, the prior channel information comprising the time difference of arrival has the advantageous effect of predicting/estimating time difference of arrival of the user terminal as training set or fingerprint and usage of positioning (e.g. receive signal time difference (RSTD) method).

Among others, the prior channel information comprising the first path power has the advantageous effects of predicting/estimating the first arriving path power of the user terminal as training set or fingerprint and of identifying LOS and NLOS link because the first arriving path power of LOS link will normally larger than that of NLOS link.

Among others, the prior channel information comprising the first arriving path power PDF has the advantageous effect of identifying LOS and NLOS link when combining with local channel information of the user terminal.

Among others, the prior channel information comprising the mean excess delay has the advantageous effect of predicting/estimating mean excess delay of the user terminal as training set or fingerprint.

Among others, the prior channel information comprising the delay spread has the advantageous effect of predicting/estimating delay spread of the user terminal as training set or fingerprint.

Among others, the prior channel information comprising the delay of strongest power path to the first arriving path has the advantageous effect of predicting/estimating delay of strongest power path to the first arriving path of the user terminal as a training set or fingerprint and identifying LOS and NLOS link.

Among others, the prior channel information comprising the delay spread PDF has the advantageous effect of identifying LOS and NLOS links.

Among others, the prior channel information comprising the kurtosis has the advantageous effect of predicting/estimating kurtosis of the user terminal as training set or fingerprint, identifying LOS link and NLOS link and estimating location of the user terminal when combining with the local channel information of the user terminal.

Among others, the prior channel information comprising the kurtosis PDF has the advantageous effect of identifying LOS link and NLOS link when combining with the local channel information of the user terminal.

Among others, the prior channel information comprising the skewness has the advantageous effect of predicting/estimating kurtosis of the user terminal as training set or fingerprint, identifying LOS link and NLOS link and estimating location of the user terminal when combining with the local channel information of the user terminal.

Among others, the prior channel information comprising the skewness PDF has the advantageous effect of identifying LOS link and NLOS link when combining with the local channel information of the user terminal.

Among others, the prior channel information comprising the angle has the advantageous effect of predicting/estimating angle of the user terminal as training set or fingerprint and usage of positioning (e.g. angle based methods).

Among others, the prior channel information comprising the angle spread has the advantageous effect of predicting/estimating angle spread of the user terminal as training set or fingerprint.

Among others, the prior channel information comprising the angle spread PDF has the advantageous effect of identifying LOS and NLOS links.

Among others, the prior channel information comprising the Rician K-factor has the advantageous effect of predicting/estimating Rician K-factor of the user terminal as training set or fingerprint.

Among others, the prior channel information comprising the Rician K-factor PDF has the advantageous effect of identifying LOS and NLOS links.

Among others, the prior channel information comprising the confidence level has the advantageous effect of that the user terminal acknowledging whether the prior channel information is reliable or not when the confidence level is provided in the prior channel information.

Among others, the prior channel information comprising the coordinate of the at least one second wireless network node or the at least one wireless terminal has the advantageous effect of estimating location of user terminal when combining with local channel information of the user terminal.

Preferably, the wireless communication method further comprises transmitting, to the network entity or the first wireless network node, a signal indicating a capability of the user terminal receiving the prior channel information.

Preferably, the wireless communication method further comprises transmitting, to the network entity or the first wireless network node, a request for the prior channel information.

Preferably, the wireless communication method further comprises transmitting, to the network entity or the first wireless network node, a signal indicating contents comprised in the prior channel information.

Preferably, the at least one characteristic of the user terminal comprises at least one of at least one channel characteristic of the at least one channel of the user terminal, a location of the user terminal, information indicating the at least one channel of the user terminal being a line-of-sight, LOS, channel or non-LOS, NLOS, channel or a velocity of the user terminal.

Preferably, the wireless communication method further comprises transmitting, to the network entity or the first wireless network node, the at least one characteristic.

Preferably, the wireless communication method further comprises:

receiving, from the first wireless network node, control information of configuring reference signal and/or data channel transmissions between the wireless terminal and the first wireless network node based on the at least one characteristic, and performing a transmission with the first wireless network node based on the control information.

Preferably, the at least one second wireless network node comprises the first wireless network node.

Preferably, the network entity resides in a core network, the first wireless network node or at least one of the at least one second wireless network node.

The present disclosure relates to a wireless communication method for use in a first wireless network node. The wireless communication method comprises transmitting prior channel information related to at least one channel between each of at least one wireless terminal and each of at least one second wireless network node.

Various embodiments may preferably implement the following features:

Preferably, the prior channel information is broadcasted to at least one user terminal or transmitted to a user terminal.

Preferably, the prior channel information comprises at least one of: channel impulse response, CIR; reference signal received power, RSRP; relative RSRP; path loss; relative path loss; path loss model; the first arriving path time; time difference of arrival; the first arriving path power; first arriving path power probability distribution function, PDF, of the first arriving path power; mean excess delay; delay spread; delay of strongest power path to the first arriving path; kurtosis; kurtosis PDF; skewness; skewness PDF; angle information, comprising at least one of: zenith of arrival, azimuth of arrival, zenith of departure or azimuth of departure; angle spread information, comprising at least one of: zenith angle spread of arrival, azimuth angle spread of arrival, zenith angle spread of departure or azimuth angle spread of departure; angle spread PDF of the angle spread, Rician K-factor; Rician K-factor PDF of the Rician K-factor; confidence level of the prior channel information; coordinate of each of the at least one second wireless network node, or coordinate of each of the at least one wireless terminal.

Preferably, the wireless communication method further comprises receiving, from a user terminal, a signal indicating a capability of the user terminal receiving the prior channel information.

Preferably, the wireless communication method further comprises receiving, from a user terminal, a request for the prior channel information.

Preferably, the prior channel information is transmitted periodically, aperiodically or semi-persistently.

Preferably, the wireless communication method further comprises receiving, from a user terminal, a signal indicating contents comprised in the prior channel information.

Preferably, the wireless communication method further comprises receiving, from a user terminal, at least one characteristic of the user terminal determined based on the prior channel information.

Preferably, the at least one characteristic of the user terminal comprises at least one of a channel characteristic of the at least one channel of the user terminal, a location of the user terminal, information indicating the at least one channel of the user terminal being a line-of-sight, LOS, channel or non-LOS, NLOS, channel or a velocity of the user terminal.

Preferably, the wireless communication method further comprises:

transmitting, to the user terminal, control information of configuring reference signal and/or data channel transmissions based on the at least one characteristic of the wireless terminal, and

performing a transmission with the user terminal based on the control information.

Preferably, the at least one second wireless network node comprises the first wireless network node

Preferably, the wireless communication method further comprises receiving, from a network entity, the prior channel information, wherein the network entity resides in a core network, the first wireless network node or at least one of the at least one second wireless network node.

The present disclosure relates to a wireless communication method for use in a wireless terminal. The wireless communication method comprises:

receiving, from at least one wireless network node, reference signals on at least one channel,

determining channel information related to the at least one channel based on the reference signals, and

transmitting, to a network entity, the channel information.

Various embodiments may preferably implement the following features:

Preferably, the channel information comprises at least one of: channel impulse response, CIR; reference signal received power, RSRP; relative RSRP; path loss; relative path loss; path loss model; the first arriving path time; time difference of arrival; the first arriving path power; first arriving path power probability distribution function, PDF, of the first arriving path power; mean excess delay; delay spread; delay of strongest power path to the first arriving path; kurtosis; kurtosis PDF; skewness; skewness PDF; angle information, comprising at least one of: zenith of arrival, azimuth of arrival, zenith of departure or azimuth of departure; angle spread information, comprising at least one of: zenith angle spread of arrival, azimuth angle spread of arrival, zenith angle spread of departure or azimuth angle spread of departure; angle spread PDF of the angle spread, Rician K-factor; Rician K-factor PDF of the Rician K-factor; confidence level of the prior channel information; coordinate of each of the at least one wireless network node, or coordinate of the wireless terminal.

Preferably, the network entity resides in a core network or at least one of the at least one wireless network node.

The present disclosure relates to a wireless communication method for use in a network entity. The wireless communication method comprises:

receiving, from at least one wireless terminal, channel information related to at least one channel between each of the at least one wireless terminal and each of at least one wireless network node as prior channel information, and

transmitting, to a user terminal, the prior channel information.

Various embodiments may preferably implement the following features:

Preferably, the prior channel information comprises at least one of: channel impulse response, CIR; reference signal received power, RSRP; relative RSRP; path loss; relative path loss; path loss model; the first arriving path time; time difference of arrival; the first arriving path power; first arriving path power probability distribution function, PDF, of the first arriving path power; mean excess delay; delay spread; delay of strongest power path to the first arriving path; kurtosis; kurtosis PDF; skewness; skewness PDF; angle information, comprising at least one of: zenith of arrival, azimuth of arrival, zenith of departure or azimuth of departure; angle spread information, comprising at least one of: zenith angle spread of arrival, azimuth angle spread of arrival, zenith angle spread of departure or azimuth angle spread of departure; angle spread PDF of the angle spread, Rician K-factor; Rician K-factor PDF of the Rician K-factor; confidence level of the prior channel information; coordinate of each of the at least one wireless network node, or coordinate of each of the at least one wireless terminal.

Preferably, the network entity resides in a core network or at least one of the at least one wireless network node.

Preferably, the wireless communication method further comprises receiving, from the user terminal, a signal indicating a capability of the user terminal receiving the prior channel information.

Preferably, the wireless communication method further comprises receiving, from the user terminal, a request for the prior channel information.

Preferably, the wireless communication method further comprises receiving, from the user terminal, a signal indicating contents comprised in the prior channel information.

The present disclosure relates to a user terminal. The user terminal comprises:

a communication unit, configured to receive, from a network entity or a first wireless network node, prior channel information related to at least one channel between each of at least one wireless terminal and each of at least one second wireless network node, and

a processor, configured to determine at least one characteristic of the user terminal based on the prior channel information.

Various embodiments may preferably implement the following feature:

Preferably, the processor is further configured to perform a wireless communication method of any of the foregoing described methods.

The present disclosure relates to a first wireless network node. The first wireless network node comprises a communication unit, configured to transmit prior channel information related to at least one channel between each of at least one wireless terminal and each of at least one second wireless network node.

Various embodiments may preferably implement the following feature:

Preferably, the first wireless network node further comprises a processor configured to perform a wireless communication method of any of the foregoing described methods.

The present disclosure relates to a wireless terminal. The wireless terminal comprises:

a communication unit, configured to receive, from at least one wireless network node, reference signals on at least one channel, and

a processor, configured to determine channel information related to the at least one channel based on the reference signals,

wherein the communication unit is further configured to transmit, to a network entity, the channel information.

Various embodiments may preferably implement the following feature:

Preferably, the processor is further configured to perform a wireless communication method of any of the foregoing described methods.

The present disclosure relates to a network entity. The network entity comprises:

a communication unit, configured to:

receive, from at least one wireless terminal, channel information related to at least one channel between each of the at least one wireless terminal and each of at least one wireless network node as prior channel information, and

transmit, to a user terminal, the prior channel information.

Various embodiments may preferably implement the following feature:

Preferably, the network entity further comprises a processor configured to perform a wireless communication method of any of the foregoing described methods.

The present disclosure relates to a computer program product comprising a computer-readable program medium code stored thereupon, the code, when executed by a processor, causing the processor to implement a wireless communication method of any of the foregoing described methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a schematic diagram of a wireless terminal according to an embodiment of the present disclosure.

FIG. 2 shows an example of a schematic diagram of a wireless network node according to an embodiment of the present disclosure.

FIG. 3 shows a schematic diagram of a wireless communication system according to an embodiment of the present disclosure.

FIG. 4 shows a schematic diagram of a wireless communication system according to an embodiment of the present disclosure.

### DETAILED DESCRIPTION

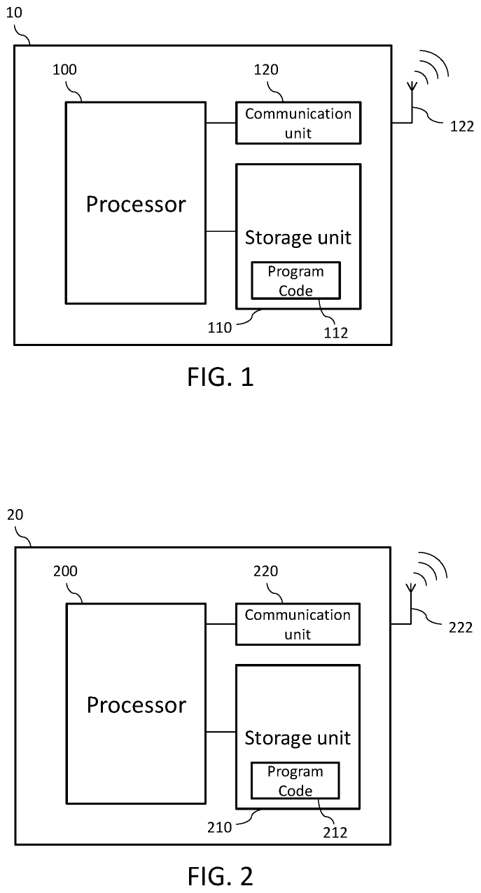

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g. messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g. a base station).

FIG. 2 relates to a schematic diagram of a wireless network node 20 according to an embodiment of the present disclosure. The wireless network node 20 may be a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g. messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g. a user equipment).

In the present disclosure, a link may be equal to a channel.

The present disclosure provides a wireless communication system comprising at least one wireless terminal, a network entity, at least one BS (e.g. a wireless network node) and at least one UE (e.g. a handheld). In an embodiment, the wireless terminal is configured to determine (e.g. detect) its channel information and transmit the channel information to the network entity. The network entity is configured to collect and store the channel information from the wireless terminal(s) as prior channel information and transmits the prior channel information to the UE, e.g., via the BS(s). Based on the prior channel information, the UE is able to determine (e.g. predict) its characteristic(s) (e.g. channel characteristic(s), location, links being light-of-sight (LOS) link(s) and or non-LOS (NLOS) or velocity) more accurately.

More specifically, the wireless terminal is a special equipment whose location (e.g. coordinate) may be measured by some tools. For example, the wireless terminal may be an anchor, a landmark, a sensor and/or a mobile platform. In an embodiment, the wireless terminal is configured to receive signals (e.g. reference signals) from each of the BSs on the channel(s), to determine its channel information (i.e. channel characteristic(s)) of the channel(s) based on the reference signals and to transmit the channel information to the network entity.

In an embodiment, the BS(s) transmitting the signals to the wireless terminal may also be anchor(s), landmark(s), and/or mobile platform(s).

In an embodiment, the channel characteristic(s) detected (e.g. determined) by the wireless terminal may comprises at least one of channel characteristics in Table I shown as the following:

TABLE I
Channel characteristics

| Chanel characteristics | symbol | Detailed definitions/descriptions |
|---|---|---|
| CIR | h_{i,j}(t) | The channel impulse response of the link between |
| | | 1^{th} node and j^{th} node |
| | | Possible usages/advantages: |
| | | Predict/estimate CIR of UE(s) as training |
| | | set or fingerprint |
| | | Extract (e.g. calculate) other kinds of |
| | | channel characteristics from (e.g. based |
| | | on) CIR for use in UE(s) |
| RSRP | RSRP_{i,j} | Reference Signal Received Power |
| | | Possible usages/advantages: |
| | | Predict/estimate RSRP of UE(s) as training |
| | | set or fingerprint |
| | | Combine with local channel information of |
| | | UE(s) and coordinates of nodes to estimate |
| | | the location of UE(s) |
| Relative RSRP | RSRP_{i,j}^{R} | RSRP_{i,j}^{R} = RSRP_{i,j}/RSRP_{ref} where |
| | | RSRP_{ref} is a reference RSRP, which may refer |
| | | to one of determined RSRP among links. When |
| | | the same channel measured by different kinds of |
| | | wireless terminals, different RSRPs may be |
| | | acquired but normally the same or similar relative |
| | | RSRP may be expected. |
| | | Possible usages/advantages: |
| | | Predict/estimate relative RSRP of UE(s) as |
| | | training set or fingerprint |
| | | Combine with local channel information of |
| | | UE(s) and coordinate of nodes to estimate |
| | | the location of UE(s) |
| Path loss | α_{i,j} | Path loss of the link between 1^{th} node and j^{th} node. |
| | | Possible usages/advantages: |
| | | Predict/estimate path loss of UE(s) as |
| | | training set or fingerprint |
| | | Combine with local channel information of |
| | | UE(s) and coordinate of nodes to estimate |
| | | the location of UE(s) |
| | | Benefit the cell selection for UE, because |
| | | small path loss of the link is preferred |
| Relative path loss | α_{i,j}^{R} | α_{i,j}^{R} = α_{i,j}/α_{ref} where α_{ref} is a reference |
| | | path loss, which may refer to one of estimated |
| | | path loss among links. When the same channel |
| | | measured by different kinds of wireless terminal, |
| | | different path losses may be acquired but normally |
| | | the same or similar relative path loss can be expected. |
| | | Possible usages/advantages: |
| | | Predict/estimate relative path loss of UE(s) |
| | | as training set or fingerprint |
| | | Combine with local channel information of |
| | | UE(s) and coordinate of nodes to estimate |
| | | the location of UE(s) |
| | | Benefit the cell selection for UE, because |
| | | small path loss of the link is preferred |
| Path loss model | | The path loss model is derived from path losses of |
| | | multiple links and the model may depend on |
| | | relative distance between BSs, signal frequency, |
| | | the heights of BS(s) and wireless terminal(s). |
| | | Possible usages/advantages: |
| | | Combine with local path loss of UE(s) to |
| | | estimate the relative distance between |
| | | BS(s) and UE(s) for positioning |
| RSRQ | RSRQ_{i,j} | Reference Signal Received Quality |
| | | Possible usages/advantages: |
| | | Predict/estimate RSRQ of UE(s) as |
| | | training set or fingerprint |
| | | Combine with local channel information of |
| | | UE(s) and coordinate of nodes to estimate |
| | | the location of UE(s) |
| Relative RSRQ | RSRQ_{i,j}^{R} | RSRQ_{i,j}^{R} = RSRQ_{i,j}/RSRQ_{ref},where |
| | | RSRQ_{ref} is a reference RSRQ, which may refer |
| | | to one of estimated RSRQ among links. When the |
| | | same channel measured by different kinds of |
| | | wireless terminals, different RSRQ may be |
| | | acquired but normally the same or similar relative |
| | | RSRQ can be expecteed. |
| | | Possible usages/advantages: |
| | | Predict/estimate relative RSRQ of UE(s) as |
| | | training set or fingerprint |
| | | Combine with local channel information of |
| | | UE(s) and coordinate of BS(s) to estimate |
| | | the location of UE(s) |
| First arriving path | τ_{i,j}⁰ | The earliest time of receiving reference signals |
| time | | among multiple paths comprised in each channel. |
| | | Possible usages/advantages: |
| | | Predict/estimate the first arriving path time |
| | | of UE(s) as training set or fingerprint |
| | | The first arriving path time may be used |
| | | for positioning (e.g. TOA method) |
| Time difference of arrival | τ_{p,q}^{diff} | $\begin{matrix}In an embodiment , \\ {τ}_{p , q}^{diff} = ( {τ}_{i , p}^{0} - {τ}_{i , q}^{0} ) , where ( p \neq q ) .\end{matrix}$ |
| | | Possible usages/advantages: |
| | | Predict/estimate time difference of arrival |
| | | of UE(s) as training set or fingerprint |
| | | The first arriving path time may be used |
| | | for positioning (e.g. RSTD method) |
| First arriving path | P_{i,j}⁰ | The power of the first arriving path. |
| power | | Possible usages/advantages: |
| | | Predict/estimate the first arriving path |
| | | power of UE(s) as training set or fingerprint |
| | | Identify LOS and NLOS link because the |
| | | first arriving path power of LOS link will |
| | | normally larger than that of NLOS link. |
| First arriving path | | The distribution of the first arriving path power |
| power probability | | which counts in multiple links. The distribution |
| distribution function | | may be a normal distribution, and the mean and |
| (PDF) | | standard deviation are included as a part of the |
| | | prior channel information. |
| | | Possible usages/advantages: |
| | | Combine with local channel information of |
| | | UE(s) to identify LOS and NLOS link |
| | | because the first arriving path power of |
| | | LOS link will normally larger than NLOS link. |
| Mean excess delay | τ_{i,j} | ${τ}_{i , j} = \frac{{\int }_{- ∞}^{∞} t {\vert {h}_{i , j} ( T ) \vert}^{2} dt}{{\int }_{- ∞}^{∞} {\vert {h}_{i , j} ( T ) \vert}^{2} dt}$ |
| | | Possible usages/advantages: |
| | | Predict/estimate mean excess delay of |
| | | UE(s) as training set or fingerprint |
| Delay spread | τ_{i,j}^{rms} | ${τ}_{i , j}^{rms} = \frac{{\int }_{- ∞}^{∞} {( t - {τ}_{i , j} )}^{2} {\vert {h}_{i , j} ( t ) \vert}^{2} dt}{{\int }_{- ∞}^{∞} {\vert {h}_{i , j} ( t ) \vert}^{2} dt}$ |
| | | Possible usages/advantages: |
| | | Predict/estimate delay spread of UE(s) as |
| | | training set or fingerprint |
| Delay of strongest power path to the first arriving path | $\begin{matrix}{τ}_{i , j}^{strongest} \\ - {τ}_{i , j}^{0}\end{matrix}$ | τ_{i,j}^{strongest} refers to the arriving path time with strongest power. Possible usages/advantages: |
| | | Predict/estimate delay of strongest power |
| | | path to the first arriving path of UE(s) as |
| | | training set or fingerprint |
| | | Identify LOS and NLOS link because the |
| | | first arriving path of LOS link will |
| | | normally has the strongest power, so the |
| | | delay of strongest power path to the first |
| | | arriving path will be proximate to zero. |
| Delay spread PDF | | The distribution of delay spread which counts in |
| | | multiple links, where the links may have |
| | | following conditions, |
| | | All links are LOS links |
| | | All links are NLOS links |
| | | Hybrid LOS and NLOS links |
| | | The distribution may be a normal distribution, |
| | | then the mean and standard deviation are included |
| | | as a part of prior channel information. |
| | | Possible usages/advantages: |
| | | Combine with local channel information |
| | | of UE(s) to identify LOS and NLOS link |
| | | because the delay spread of LOS link will |
| | | normally smaller than that of NLOS link. |
| Kurtosis | K_{i,j} | ${K}_{i , j} = \frac{E ⌊ {( \vert {h}_{i , j} ( t ) \vert - {μ}_{\vert {h}_{i , j} \vert} )}^{4} ⌋}{{δ}_{\vert {h}_{i , j} \vert}^{4}}$ |
| | | where E (·) denotes expectation over delay, and |
| | | ${μ}_{{h}_{i , j}} and {δ}_{{h}_{i , j}} are the mean and deviation of$ |
| | | \|h_{i,j}\|, respectively. |
| | | Possible usages/advantages: |
| | | Predict/estimate kurtosis of UE(s) as |
| | | training set or fingerprint |
| | | Identify LOS and NLOS link because |
| | | kurtosis of LOS link will normally larger |
| | | than NLOS link. |
| | | Combine with local channel information |
| | | of UE(s) and coordinate of BS(s) to |
| | | estimate the location of UE(s) |
| Kurtosis PDF | | The distribution of kurtosis which counts in |
| | | multiple links, where the links may have |
| | | following conditions, |
| | | All links are LOS links |
| | | All links are NLOS links |
| | | Hybrid LOS and NLOS links |
| | | The distribution may be a normal distribution, |
| | | then the mean and standard deviation are included |
| | | as a part of prior channel information. |
| | | Possible usages/advantages: |
| | | Combine with local channel information of |
| | | UE(s) to identify LOS and NLOS link |
| | | because kurtosis of LOS link will normally |
| | | larger than NLOS link. |
| Skewness | s_{i,j} | ${s}_{i , j} = \frac{E ⌊ {( \vert {h}_{i , j} ( t ) \vert - {μ}_{\vert {h}_{i , j} \vert} )}^{3} ⌋}{{δ}_{\vert {h}_{i , j} \vert}^{3}}$ |
| | | where E (·) denotes expectation over delay, and |
| | | ${μ}_{{h}_{i , j}} and {δ}_{{h}_{i , j}} are the mean and deviation of$ |
| | | \|h_{i,j}\|, respectively. |
| | | Possible usages/advantages: |
| | | Predict/estimate skewness of UE(s) as |
| | | training set or fingerprint |
| | | Identify LOS and NLOS link because |
| | | skewness of LOS link will normally larger |
| | | than NLOS link. |
| Skewness PDF | | The distribution of Skewness which counts in |
| | | multiple links, where the links may have |
| | | following conditions, |
| | | All links are LOS links |
| | | All links are NLOS links |
| | | Hybrid LOS and NLOS links |
| | | The distribution may be a normal distribution, |
| | | then the mean and standard deviation are included |
| | | as a part of prior channel information. |
| | | Possible usages/advantages: |
| | | Combine with local channel information of |
| | | UE(s) to identify LOS and NLOS link |
| | | because skewness of LOS link will |
| | | normally larger than NLOS link |
| Angle | ZOA_{i,j}, AOA_{i,j} | ZOA, AOA, ZOD, AOD respectively refer to |
| | ZOD_{i,j}, AOD_{i,j} | zenith of arrival, azimuth of arrival, zenith of |
| | | departure and azimuth of departure. |
| | | Possible usages/advantages: |
| | | Predict/estimate angle of UE(s) as training |
| | | set or fingerprint |
| | | The angle may be used for positioning |
| | | (e.g. angle based methods) |
| Angle spread | ZSA_{i,j}, ASA_{i,j} | ZSA, ASA, ZSD, ASD respectively refer to zenith |
| | ZSD_{i,j} ASD_{i,j} | angle spread of arrival, azimuth angle spread of |
| | | arrival, zenith angle spread of departure, azimuth |
| | | angle spread of departure. |
| | | Possible usages/advantages: |
| | | Predict/estimate angle spread of UE(s) as |
| | | training set or fingerprint |
| Angle spread PDF | | The distribution of angle spread which counts in |
| | | multiple links. The distribution may be a normal |
| | | distribution, then the mean and standard deviation |
| | | are included as a part of prior channel information. |
| | | Possible usages/advantages: |
| | | Combine with local channel information of |
| | | UE(s) to identify LOS and NLOS link |
| | | because the angle spread of LOS link will |
| | | normally smaller than NLOS link. |
| Rician K-factor | K_{R}_{_{i,j}} | The Rician K-factor is the ratio of the power in the |
| | | direct field to the power in the reflected field. |
| | | Possible usages/advantages: |
| | | Predict/estimate Rician K-factor of UE(s) |
| | | as training set or fingerprint |
| Rician K-factor PDF | | The distribution of Rician K-factor which counts |
| | | in multiple links. The distribution may be a |
| | | normal distribution, then the mean and standard |
| | | deviation are included as a part of prior channel |
| | | information. |
| | | Possible usages/advantages: |
| | | Combine with local channel information of |
| | | UE(s) to identify LOS and NLOS link |
| | | because the Rician K-factor of LOS link |
| | | will normally larger than NLOS link. |
| Confidence level | C ∈ (0, 100%) | For example, some measured channel |
| | | characteristics can be attached with confidence |
| | | level that shows the uncertainty of measurements. |
| | | Possible usages/advantages: |
| | | If confidence level is provided in prior |
| | | channel information corresponding to |
| | | specific channel characteristic(s), UE can |
| | | acknowledge whether the prior channel |
| | | information is reliable or not. |
| Coordinate of | | The nodes may comprise BS(s) and/or wireless |
| nodes | | terminal(s). |
| | | In an embodiment, the coordinate is relative |
| | | position to a reference location in local coordinate |
| | | system or absolute position in the global |
| | | coordinate system. |
| | | Possible usages/advantages: |
| | | Combine with local channel information of |
| | | UE(s) and corresponding channel |
| | | characteristic(s) in prior channel |
| | | information to estimate the location of |
| | | UE(s) |

In an embodiment, the network entity may be a database and is configured to collect (e.g. receive) and store the channel information from the wireless terminal(s) as the prior channel information. In an embodiment, the database transmits the prior channel information to the at least one UE. In an embodiment, the database resides in a core network of the wireless communication system. In an embodiment, the database resides in at least one BS.

In the embodiment of the network entity residing in the core network, the network entity transmits the prior channel information of the wireless terminal(s) to the UE(s) directly or via the BS(s). In an embodiment, there is an interface between the network entity and the UE(s), and the network entity is able to directly transmit the prior channel information to the UE(s). In an embodiment, the network entity transmits the prior channel information to the UE(s) via the BS(s). In this embodiment, the prior channel information may be transparent to the BS(s).

In an embodiment of the network entity residing in the BS(s), the network entity transmits the prior channel information to the BS(s). In an embodiment, the BS(s) broadcasts the prior channel information to the UE(s) within a coverage of the BS(s). In an embodiment, the BS transmits the prior channel information to a specific UE.

In an embodiment, the prior channel information may be transmitted on demand, aperiodically, semi-persistently or periodically. For example, the network entity and/or the BS(s) (e.g. the BS(s) in which the network entity resides or the BS(s) having the prior channel information) may receive a request of the prior channel information from the UE(s) and transmit the prior channel information in response. In an embodiment, the network entity and/or the BS(s) may transmit the prior channel information in an aperiodic manner. In an embodiment, the network entity and/or the BS(s) may transmit the prior channel information in a semi-persistent manner (e.g. transmitting the prior channel information periodically within a specific duration).

In an embodiment, the network entity and/or the BS(s) may receive a signal (e.g. signaling) indicating a capability of receiving (e.g. decoding) the prior channel information from the UE(s). In this embodiment, the network entity and/or the BS(s) may transmit the prior channel information only to the UE(s) which reports having the capability of receiving the prior channel information.

In an embodiment, the network entity and/or the BS(s) may receive a signal indicating contents (i.e. certain channel characteristic(s)) comprised in the prior channel information from the UE(s). In this embodiment, the network entity and/or the BS(s) may include the channel characteristic(s) indicated by the signal in the prior channel information transmitted to the UE(s). In an embodiment, the indicated channel characteristic(s) may be at least one of those shown in Table I.

After receiving the prior channel information from network entity and/or the BS(s), the UE determines (e.g. predicts or estimates) its characteristic(s) based on the prior channel information. In an embodiment, the characteristic(s) determined based on the prior channel information may be the channel characteristic(s) of the UE. In an embodiment, the characteristic(s) determined based on the prior channel information may be a location of the UE. In an embodiment, the characteristic(s) determined based on the prior channel information may be information indicating that each of links (e.g. channels) of the UE is a line-of-sight (LOS) link or non-LOS (NLOS) link. In an embodiment, the characteristic(s) determined based on the prior channel information may be a velocity of the UE. In other words, the UE may utilize the prior channel information as a reference of determining its channel characteristics, determining its location, identifying its links being the LOS links or NLOS links and/or determining its velocity.

In an embodiment, the UE receives reference signals from the BS(s) on the channel(s), determines channel characteristics of the channel(s) based on the reference signals as local channel information, and determines (e.g. predicts) the characteristic(s) based on both the prior channel information and the local channel information.

In an embodiment, the UE transmits the characteristic(s) determined based on the prior channel information (and the local channel information) to the network entity and/or the BS(s) for further operations. For example, the BS(s) may configure reference signals and/or data channel transmissions based on the characteristic(s) of the UE, transmit corresponding control information to the UE and perform a transmission based on the control information. As a result, transmission performance between the UE and the BS(s) is improved.

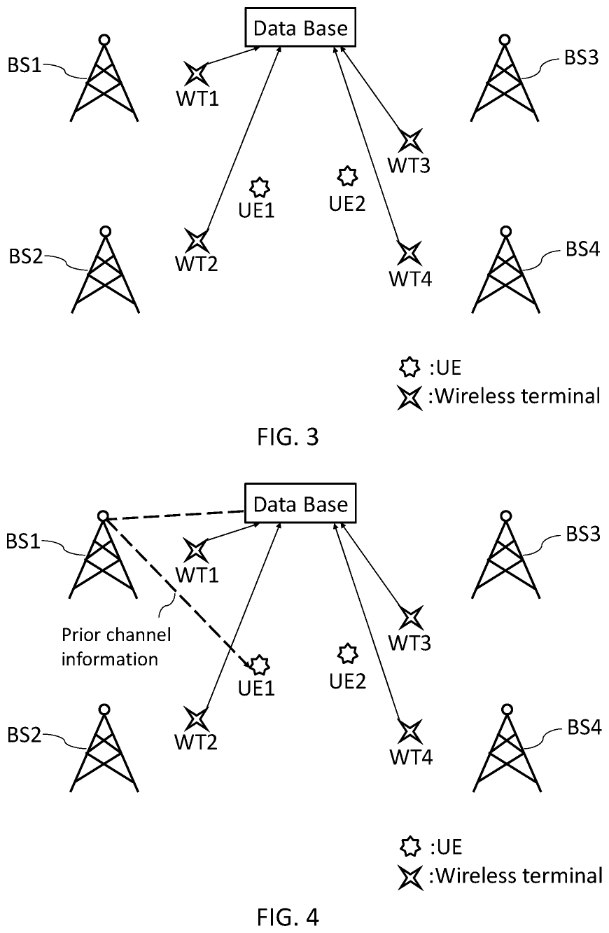

FIG. 3 shows a schematic diagram of a wireless communication system according to an embodiment of the present disclosure. In FIG. 3, the wireless communication comprises 4 BSs BS1, BS2, BS3 and BS4, two UEs UE1 and UE2, 4 wireless terminals WT1, WT2, WT3 and WT4 and a database (i.e. a network entity). In an embodiment, WT1, WT2, WT3 and WT4 and UE1 and UE2 may be respectively realized by the wireless terminal shown in FIG. 1 and BS1, BS2, BS3 and BS4 and the database may be respectively realized by the wireless network node shown in FIG. 2. Note that, the number of BSs, UEs, wireless terminals and/or database may vary and is not limited to that shown in FIG. 3. In an embodiment, the UE1 and/or UE2 receive(s) the prior channel information related to channel(s) between each of WT1, WT2, WT3 and WT4 and each of the BS1, BS2, BS3 and BS4 and determines its characteristic(s) based on the prior channel information. For example, the determined characteristic may comprise the location information, the velocity information, the channel information and/or the information of links being LOS or NLOS. Because of the prior channel information, the determined characteristic(s) would be more accurate.

More specifically, each of WT1, WT2, WT3 and WT4 may be special equipment whose location (e.g. coordinate) may be measured by some tools. In this embodiment, the wireless terminals WT1, WT2, WT3 and WT4 are configured to receive signals (e.g. reference signals) transmitted from BS1, BS2, BS3 and BS4 and determine their channel information as the prior channel information collected by the database.

In the embodiment shown in FIG. 3, the database may reside in at least one of the 4 BSs or be a separate network entity which connects with at least one of the 4 BSs. In addition, the database collects and stores the prior channel information from the wireless terminals WT1, WT2, WT3 and WT4 and corresponding locations of the wireless terminals WT1, WT2, WT3 and WT4 in the coordinate system.

In the embodiment shown in FIG. 3, BS1, BS2, BS3 and BS4 are configured to transmit/receive signals from UE1 and UE2 and/or WT1, WT2, WT3 and WT4. In an embodiment, the BS(s) connecting to the UE1 and UE2 (i.e. serving BS(s) of the UE1 and UE2) transmits the prior channel information to the UE1 and UE2. In another embodiment, the BS with the prior channel information may broadcast the prior channel information to the UE(s) within a coverage of the BS with the prior channel information.

In FIG. 3, the UE1 or UE2 may interact with its serving BS. That is, UE1 or UE2 may transmit and/or receives channels/signals from the serving BS. In an embodiment, the UE1 or UE2 may receive and decoded the prior channel information and applies the received prior channel information to predict the channel information, the location information, the LOS/NLOS identification or the velocity.

FIG. 4 shows a schematic diagram of a wireless communication system according to an embodiment of the present application. The wireless communication system shown in FIG. 4 is similar to that shown in FIG. 3, thus components with similar functions use the same symbols. In this embodiment, WT1, WT2, WT3 and WT4 receive signals from all of the BSs BS1, BS2, BS3 and BS4 and accordingly determine channel information of link(s) (i.e. channel(s)) between each of WT1, WT2, WT3 and WT4 and each of BS1, BS2, BS3 and BS4. For example, WT1, WT2, WT3 and WT4 may determine channel impulse responses (CIRs) of the link(s). In an embodiment, the CIR between i^{th} wireless terminal and j^{th} base station is denoted by h_{i,j}(t), where 1≤i≤4 and 1≤j≤4. Note that, 1^{st} wireless terminal may be the wireless terminal WT1, 2^{nd} wireless terminal may be the wireless terminal WT2 and so on. Similarly, 1^{st} BS may be BS1, 2^{nd} BS may be BS2, and so on. In an embodiment, the wireless terminals WT1, WT2, WT3 and WT4 may determine reference signal received powers (RSRPs) of links between each of the wireless terminals WT1, WT2, WT3 and WT4 and each of the BSs BS1, BS2, BS3 and BS4. In an embodiment, the RSRP between i^{th} wireless terminal and j^{th} base station is denoted by RSRP_{i,j}, where 1≤i≤4 and 1≤j≤4. In an embodiment, WT1, WT2, WT3 and WT4 may determine its location information (e.g. coordinate). For example, the location information of i^{th} wireless terminal may be denoted as [xᵢ yᵢ zᵢ].

In FIG. 4, the database collects all the location information (e.g. coordinate) and the channel information (e.g. the RSRPs) of the wireless terminals WT1, WT2, WT3 and WT4. That is, the prior channel information comprises the location information and the channel information. In an embodiment, the location information collected by the database can be represented by:

$$[ \begin{matrix}{x}_{1} & {y}_{1} & {z}_{1} \\ {x}_{2} & {y}_{2} & {z}_{2} \\ {x}_{3} & {y}_{3} & {z}_{3} \\ {x}_{4} & {y}_{4} & {z}_{4}\end{matrix} ] ,$$

wherein [xᵢ yᵢ zᵢ] denotes the coordinate of i^{th} wireless terminal. In addition, the RSRPs collected by the database may be represented by:

$$[ \begin{matrix}{RSRP}_{1 , 1} & {RSRP}_{1 , 2} & {RSRP}_{1 , 3} & {RSRP}_{1 , 4} \\ {RSRP}_{2 , 1} & {RSRP}_{2 , 2} & {RSRP}_{2 , 3} & {RSRP}_{2 , 4} \\ {RSRP}_{3 , 1} & {RSRP}_{3 , 2} & {RSRP}_{3 , 3} & {RSRP}_{3 , 4} \\ {RSRP}_{4 , 1} & {RSRP}_{4 , 2} & {RSRP}_{4 , 3} & {RSRP}_{4 , 4}\end{matrix} ]$$

Next, the database may transmit the prior channel information to UE1. In FIG. 4, the database transmits the prior channel information to the UE1 via BS1. In this embodiment, UE1 may also receive signals from all of BS1, BS2, BS3 and BS4 and accordingly determine local channel information. For example, the local RSRPs of links between the UE1 and each of BS1, BS2, BS3 and BS4 may be calculated and may be represented by:

[RSRP₁ RSRP₂ RSRP₃ RSRP₄]

Based on the received prior channel information and the calculated local channel information, UE1 may determine (e.g. predict or estimate) its location.

For example, at least one of the following algorithms can be used to estimate the location:

1. Path loss model (if provided in the prior channel information) can be used to estimate the relative distance between wireless terminal and BSs, then triangulation location based method is followed to estimate the position.

2. K-nearest neighbor (KNN) can find some nearest neighbors (e.g. anchors) of terminal (i.e. UE) and corresponding weights, which can be used for positioning.

3. Machine learning or neural artificial network uses prior channel information as training sets and the local RSRP can be a test set/target set.

Note that, there are other probabilistic approaches or kernel based approaches for determining the location. In addition, the contents comprised in the prior channel information may change based on the algorithms/approaches used for estimating the location.

In an embodiment, the prior channel information comprises the channel delay spread PDF and all of links are NLOS links in an area. In this embodiment, the distribution of the channel delay spread PDF is a normal distribution and a corresponding mean value μₙₗₒₛ and a corresponding standard deviation δₙₗₒₛ are also included as a part of the prior channel information. A wireless terminal (e.g. UE2 shown in FIG. 3) within the area may receive signals from BSs (e.g. BS1, BS2, BS3 and BS4 shown in FIG. 3) and accordingly determines its channel information. In this embodiment, the wireless terminal determines a mean excess delay based on the channel/link between i^{th} terminal and j^{th} BS which may be denoted as τ_{i,j}. Because the first arriving path generally has the largest power in the LOS link and the mean excess delay is reduced when the power of the first arriving path increases, the mean excess delay of a LOS link is high probability of being smaller than that of an NLOS link. That is, when the mean excess delay τ_{i,j} of the link is smaller, the probability of this link being the LOS link is higher. Therefore, the wireless terminal may determine the link is the LOS link when the mean excess delay τ_{i,j} of the link is smaller than a threshold value. For example, the wireless terminal may determine the link is the LOS link when τ_{i,j}≤(μₙₗₒₛ−1.5·δₙₗₒₛ). In addition, the contents comprised in the prior channel information may change based on the algorithms/approaches used for estimating LOS and NLOS link. For example, the prior channel information used for identifying the links as LOS or NLOS link may comprise at least one of first arriving path power PDF, kurtosis PDF, skewness PDF, angle spread PDF, Rician K-factor PDF.

In an embodiment, the UE may utilize the prior channel information as fingerprint of predicting its channel information and/or its location.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a user terminal, the wireless communication method comprising:
receiving, from a network entity or a first wireless network node, prior channel information related to at least one channel between each of at least one wireless terminal and each of at least one second wireless network node, and
determining at least one characteristic of the user terminal based on the prior channel information.

2. The wireless communication method of claim 1, further comprising:
receiving, from the at least one second wireless network node, reference signals on the at least one channel,
determining local channel information based on the reference signals, and
determining the at least one characteristic based on the prior channel information and the local channel information.

3. The wireless communication method of claim 1, wherein the prior channel information comprises at least one of:
delay spread probability distribution function (PDF),
kurtosis PDF,
skewness PDF,
angle spread PDF,
Rician K-factor PDF,
confidence level of the prior channel information, or
coordinate of each of the at least one wireless terminal.

4. The wireless communication method of claim 1, further comprising:
transmitting, to the network entity or the first wireless network node, a signal indicating a capability of the user terminal receiving the prior channel information,
transmitting, to the network entity or the first wireless network node, a request for the prior channel information, and
transmitting, to the network entity or the first wireless network node, a signal indicating contents comprised in the prior channel information.

5. The wireless communication method of claim 1, wherein the at least one characteristic of the user terminal comprises information indicating the at least one channel of the user terminal being a line-of-sight (LOS) channel or non-LOS (NLOS) channel.

6. The wireless communication method of claim 1, further comprising:
transmitting, to the network entity or the first wireless network node, the at least one characteristic,
receiving, from the first wireless network node, control information of configuring reference signal and/or data channel transmissions between the wireless terminal and the first wireless network node based on the at least one characteristic, and
performing a transmission with the first wireless network node based on the control information.

7. The wireless communication method of claim 1, wherein the at least one second wireless network node comprises the first wireless network node, and
wherein the network entity resides in one of a core network, the first wireless network node or at least one of the at least one second wireless network node.

8. A wireless communication method for use in a first wireless network node, the wireless communication method comprising:
transmitting, to a user terminal, prior channel information related to at least one channel between each of at least one wireless terminal and each of at least one second wireless network node.

9. The wireless communication method of claim 8, the prior channel information comprises at least one of:
delay spread probability distribution function (PDF),
kurtosis PDF,
skewness PDF,
angle spread PDF,
Rician K-factor PDF,
confidence level of the prior channel information, or
coordinate of each of the at least one wireless terminal.

10. The wireless communication method of claim 8, further comprising:
receiving, from the user terminal, a signal indicating a capability of the user terminal receiving the prior channel information,
receiving, from the user terminal, a request for the prior channel information, and
receiving, from the user terminal, a signal indicating contents comprised in the prior channel information.

11. The wireless communication method of claim 8, further comprising:
receiving, from the user terminal, at least one characteristic of the user terminal determined based on the prior channel information,
wherein the at least one characteristic of the user terminal comprises information indicating the at least one channel of the user terminal being a line-of-sight (LOS) channel or non-LOS (NLOS) channel or a velocity of the user terminal, and
wherein the method further comprising:
transmitting, to the user terminal, control information of configuring reference signal and/or data channel transmissions based on the at least one characteristic of the wireless terminal, and
performing a transmission with the user terminal based on the control information.

12. The wireless communication method of claim 8, wherein the at least one second wireless network node comprises the first wireless network node, and
wherein the method further comprising:
receiving, from a network entity, the prior channel information, wherein the network entity resides in a core network, the first wireless network node or at least one of the at least one second wireless network node.

13. A wireless communication method for use in a network entity, the wireless communication method comprising:
receiving, from at least one wireless terminal, channel information related to at least one channel between each of the at least one wireless terminal and each of at least one wireless network node as prior channel information, and
transmitting, to a user terminal, the prior channel information.

14. The wireless communication method of claim 13, wherein the prior channel information comprises at least one of:
delay spread probability distribution function (PDF),
kurtosis PDF,
skewness PDF,
angle spread PDF,
Rician K-factor PDF,
confidence level of the prior channel information, or
coordinate of each of the at least one wireless terminal.

15. The wireless communication method of claim 13, wherein the network entity resides in a core network or at least one of the at least one wireless network node.

16. The wireless communication method of claim 13, further comprising:
receiving, from the user terminal, a signal indicating a capability of the user terminal receiving the prior channel information,
receiving, from the user terminal, a request for the prior channel information, and
receiving, from the user terminal, a signal indicating contents comprised in the prior channel information.

17. A user terminal, comprising a processor being configured to carry out the method of claim 1.

18. A first wireless network node comprising a processor being configured to carry out the method of claim 8.

19. A network entity, comprising a processor being configured to carry out the method of claim 13.
